(19) United States
(12) Patent Application Publication
(10) Pub. No.: US 2012/0153750 A1
(43) Pub. Date: Jun. 21, 2012

(54) Base assembly for motor and motor including the same

(75) Inventors: Sang Won Kim, Gunpo (KR); Jun Seop Shin, Seongnam (KR)

(73) Assignee: SAMSUNG ELECTRO-MECHANICS CO., LTD., Suwon (KR)

(21) Appl. No.: 12/929,615

(22) Filed: Feb. 3, 2011

(30) Foreign Application Priority Data
Dec. 20, 2010 (KR) 10-2010-0130716

(51) Int. Cl. H02K 11/00

(52) U.S. Cl. 310/71

(57) ABSTRACT

There is provided a base assembly for a motor, including: a base member including at least one coil hole having a lead wire of a coil passing therethrough and having an inner surface formed to be stepped, the coil generating a rotational driving force of a motor; an insulating member inserted into the coil hole to be fixed thereto in order to prevent contact between the lead wire and the base member; and a printed circuit board disposed on a lower surface of the base member, coupled to one surface of the insulating member, and electrically connected to one end of the lead wire.

### CROSS-REFERENCE TO RELATED APPLICATIONS

This application claims the priority of Korean Patent Application No. 10-2010-0130716 filed on Dec. 20, 2010, in the Korean Intellectual Property Office, the disclosure of which is incorporated herein by reference.

### BACKGROUND OF THE INVENTION

1. Field of the Invention

The present invention relates to a base assembly for a motor capable of insulating a lead wire of a coil by changing the shapes or the coupling structure of a coil hole and an insulating member configuring the base assembly for a motor, and a motor including the same.

2. Description of the Related Art

A motor generating driving force has been mounted in a hard disk drive (HDD) or an optical disc drive (ODD), both of which are computer information storage devices.

The motor, which is a device converting electrical energy into dynamic energy using magnetic force generated by a conductor in which current flows, generates driving force by electromagnetic force between a magnet and a coil.

Accordingly, in order to rotate the motor by the electromagnetic force, current needs to flow in the coil electrically connected to an outer portion of the motor. Therefore, one end of the coil needs to be led to the outside.

However, since the lead wire of the coil needs to pass through a base made of a conductive material, disconnection of the lead wire has been caused due to unnecessary electrical contact between the lead wire and the base.

Meanwhile, in order to prevent the disconnection of the lead wire of the coil, a method of bonding an insulating member provided with a hole having a smaller diameter than that of a hole on the base through which the lead wire passes and made of an insulating material to upper and lower portions of the base to insulate the lead wire, and the like, has been used, according to the related art.

However, since the insulating member needs to be bonded to the upper surface or both surfaces of the base in the above-mentioned method, a process of overturning the base during the bonding of the insulating member to the base has been added, thereby complicating a manufacturing process.

In addition, since a case in which the lead wire is bent within the hold formed in the base to be disconnected has also been generated, insulation has been not stably created.

### SUMMARY OF THE INVENTION

An aspect of the present invention provides a base assembly for a motor capable of insulating a lead wire of a coil, by changing the shapes or the coupling structure of a coil hole and an insulating member configuring the base assembly for a motor, and a motor including the same.

According to an aspect of the present invention, there is provided a base assembly for a motor, including: a base member including at least one coil hole having a lead wire of a coil passing therethrough and having an inner surface formed to be stepped, the coil generating a rotational driving force of a motor; an insulating member inserted into the coil hole to be fixed thereto in order to prevent contact between the lead wire and the base member; and a printed circuit board disposed on a lower surface of the base member, coupled to one surface of the insulating member, and electrically connected to one end of the lead wire.

The coil hole may include a plurality of coil holes, and the insulating member may be configured of the small diameter parts inserted into the plurality of coil holes formed to be spaced apart from each other and having a relatively small outer diameter and the large diameter parts extended from one end of the small diameter parts to be connected to each other.

insulating member may be configured of small diameter parts having a relatively small outer diameter and large diameter parts having a relatively large outer diameter.

The insulating member may be configured of the small diameter parts inserted into the plurality of coil holes formed to be spaced from each other and having a relatively small outer diameter and the large diameter parts formed to be extended from one end of the small diameter parts to be connected to each other.

The coil hole may have a shape corresponding to the insulating member.

One end of the insulating member may be formed to be higher than an upper surface of the base member.

The insulating member may have a constant inner diameter.

The inner surface of the coil hole may have a stepped shape in which a diameter of a lower portion thereof is larger than that of an upper portion thereof.

The printed circuit board may further include a closing part closing the coil hole by soldering one end of the lead wire of the coil.

According to an aspect of the present invention, there is provided a motor, including: a base assembly for a motor as described above; a base assembly for a motor of any one of claims 1 to 8; a sleeve having the base assembly coupled to an outer peripheral surface thereof and having a shaft inserted thereinto to be supported; a core fixedly disposed on an upper portion of the base assembly and having a coil wound therearound, the coil generating the rotational driving force; and a rotor having a magnet mounted therein such that the rotor is coupled to the shaft to be rotated, the magnet being faced to the coil.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a motor according to an exemplary embodiment of the present invention;

FIG. 2 is a partially enlarged cross-sectional view schematically showing part A of FIG. 1;

FIG. 3 is an exploded perspective view schematically showing a base assembly for a motor according to another exemplary embodiment of the present invention;

FIG. 4 is a partial cross-sectional view schematically showing a first example of a modified insulating member according to another exemplary embodiment of the present invention;

FIG. 5 is a perspective cross-sectional view schematically showing a second example of a modified insulating member according to another exemplary embodiment of the present invention; and

FIG. 6 is a partial perspective view schematically showing a modified example of a base member according to another exemplary embodiment of the present invention.

### DETAILED DESCRIPTION OF THE PREFERRED EMBODIMENT

Exemplary embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, throughout the drawings, the same or similar reference numerals will be used to designate the same components or like components having the same functions in the scope of the similar idea.

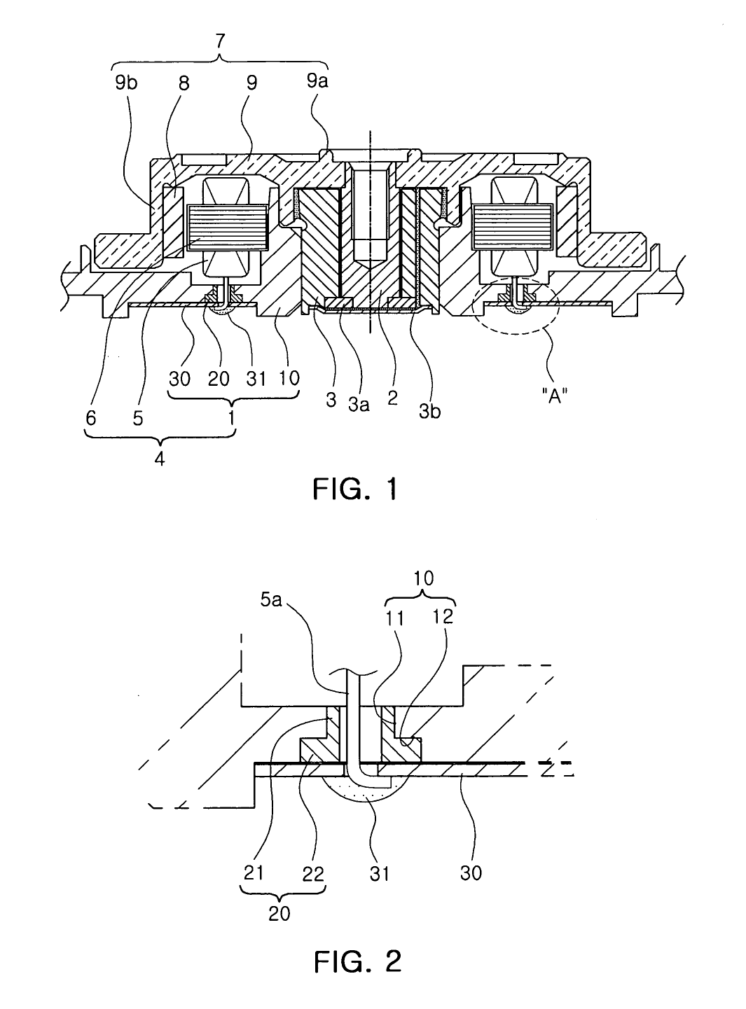

FIG. 1 is a cross-sectional view schematically showing a motor according to an exemplary embodiment of the present invention, and FIG. 2 is a partially enlarged cross-sectional view schematically showing part A of FIG. 1.

Referring to FIGS. 1 and 2, a motor according to an exemplary embodiment of the present invention may be configured to include a sleeve 3, a rotor 7, and a stator 4, wherein the stator 4 may include a coil 5, a core 6, and a base assembly 1.

The detailed examples of the base assembly 1 will be described below. The motor according to the present invention may have all specific characteristics of respective examples of the base assembly 1.

The sleeve 3 may have a shaft 2 inserted thereinto, and the shaft 2 may be rotated, while being supported within the sleeve 3 by hydrodynamic pressure.

In this configuration, the shaft 2 is inserted into the sleeve 3 in such a manner as to have a micro clearance disposed between the the shaft 2 and the sleeve 3. The micro clearance is filled with oil, which may more smoothly support the rotation of the shaft 2 by a radial dynamic groove formed in at least one of an outer diameter of the shaft 2 and an inner diameter of the sleeve 3. The radial dynamic groove may have a spiral shape, a herringbone shape, or the like.

Meanwhile, the motor according to an exemplary embodiment of the present invention may further include a thrust plate 3a. The thrust plate 3a is disposed on a lower portion of the sleeve 3. In addition, a hole corresponding to the cross section of the shaft 2 is formed at the center of the sleeve 3 and the shaft 2 may be inserted into the hole to be coupled thereto.

At this time, the thrust plate 3a may separately manufactured and may be coupled to the shaft 2. As a method of coupling the trust plate 3a to the shaft 2, a welding method or a bonding method may be used.

However, the thrust plate 3a may also be integrally formed with the shaft 2 at the time of manufacturing thereof, and may rotate according to the shaft 2 during the rotation of the shaft 2.

At least any one of the upper surface and the lower surface of the thrust plate 3a may be provided with a thrust dynamic groove providing thrust dynamic pressure to the shaft 2. The thrust dynamic groove may have a spiral shape, a herringbone shape, or the like, as in the above-mentioned radial dynamic groove.

In this configuration, a cover plate 3b may be coupled to the lower portion of the sleeve 3 in an axial direction, while having a clearance receiving oil disposed therebetween. The cover plate 3b may receive the oil in the clearance between the cover plate 3b and the sleeve 3 to serve as a bearing supporting the lower surface of the shaft 2.

In addition, the oil may be continuously filled in the clearance between the shaft 2 and the sleeve 3 and in the clearance between the cover plate 3b and the sleeve 3 to entirely form a full-fill structure.

Meanwhile, the structure of the shaft 2 may not be limited to a structure supported by the hydrodynamic pressure, as long as the shaft 2 may be rotated, while being supported within the sleeve 3.

The rotor 7, which is a rotational structure provided to be rotated with respect to the stator 4, may include a rotor case 9 including a ring-shaped magnet 8 formed on an outer peripheral surface thereof, the magnet being disposed to be spaced by a predetermined distance from the core 6.

In addition, as the magnet 8, a permanent magnet generating a magnetic force of a predetermined strength by alternately magnetizing an N pole and an S pole thereof in a circumferential direction is used.

In this case, the rotor case 9 is configured to include a hub base 9a press-fitted in an upper end of the shaft 2 to be fixed thereto and a magnet support portion 9b extending in an outer diameter direction from the hub base 9a and being bent downwardly in the axial direction to support the magnet 8 of the rotor 7.

The stator 4 may be a fixing structure including the coil 5 generating electromagnetic force of a predetermined magnitude when power is applied thereto and a plurality of cores 6 having the coil 5 wound therearoud.

The core 6 may be fixedly disposed on an upper portion of the base assembly 1 including a printed circuit board 30 having pattern circuits printed thereon.

Meanwhile, a lead wire 5a extendedly formed from the coil may be electrically connected to the printed circuit board 30 in order to introduce electrical energy for obtaining rotational force by the electromagnetic force.

Accordingly, current may flow in the coil 5 to convert the electrical energy into dynamic energy such as rotational energy, or the like, due to electromagnetic interaction with the magnet 8 attached to the rotor 7.

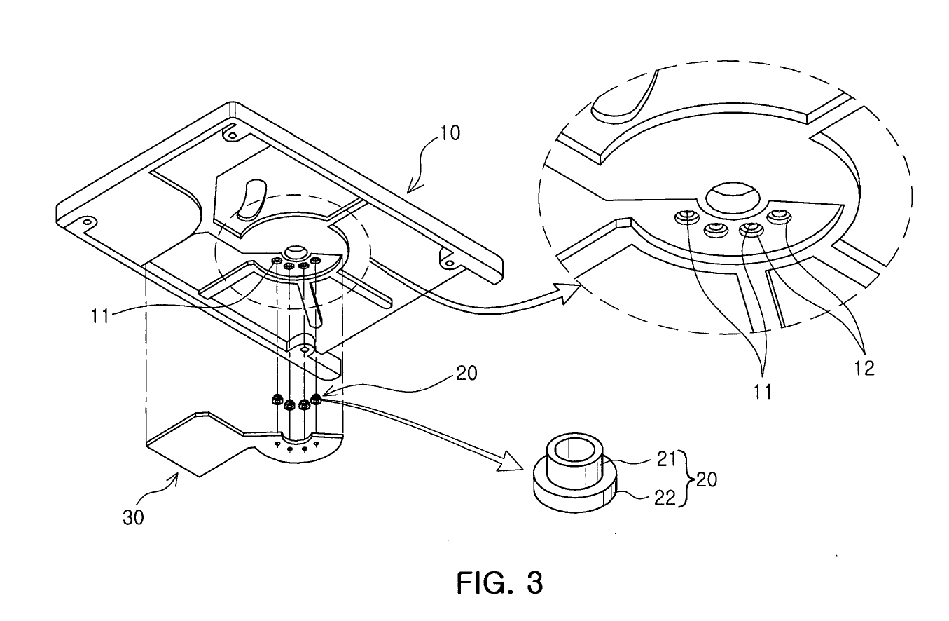

An outer peripheral surface of the sleeve 3 may be press-fitted in the base assembly 1 to be fixed thereto, and the cores 6 having the coil 5 wound therearound may be inserted into the base assembly 1. An inner surface of the base assembly 1 and an outer surface of the sleeve 3 may be assembled by applying an adhesive to the inner surface of the base assembly 1 or the outer surface of the sleeve 3. The base assembly 1 will be described in detail with reference to FIG. 3.

FIG. 3 is an exploded perspective view schematically showing a base assembly for a motor according to another exemplary embodiment of the present invention.

Referring to FIG. 3, the base assembly 1 may be configured to include a base member 10, an insulating member 20, and the printed circuit board 30.

The base member 10 may be provided with at least one coil hole 11 through which the lead wire 5a of the coil 5 passes, wherein the lead wire 5a of the coil 5 may be electrically connected to the printed circuit board 30 so that external power is supplied thereto.

The lead wire 5a is fixed to the printed circuit board 30 by soldering in order to be electrically connected to the printed circuit board 30, and a closing part 31 closing the coil hole may be formed by the soldering.

The closing part 31 may serve as a protecting body preventing foreign materials from penetrating into an inner portion of the coil hole 11, simultaneously preventing the lead wire 5a from being separated.

The coil hole 11 may be formed to have a shape in which an inner surface thereof is stepped. At least one coil hole may be formed in the base member 10. That is, the coil hole 11 may also be formed in plural.

In addition, the stepped inner surface shape of the coil hole 11 may be formed in such a manner that a diameter of a lower portion thereof is larger than that of an upper portion thereof.

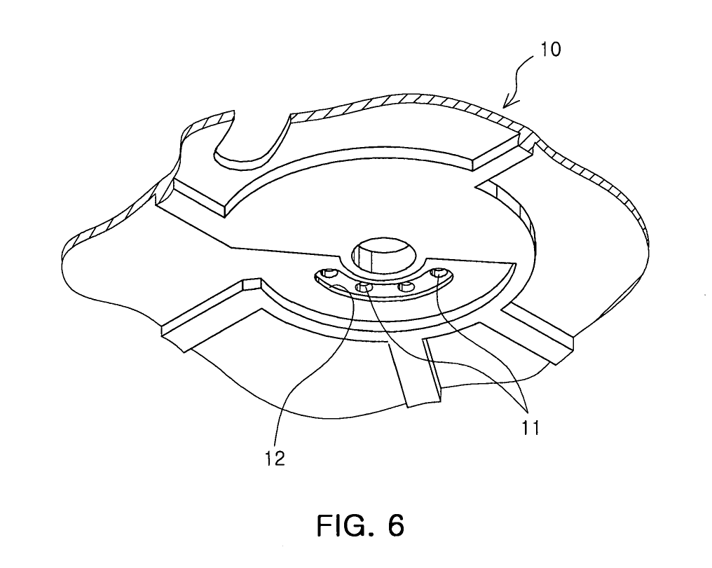

Meanwhile, the lower portions of the stepped inner surface shapes of a plurality of coil holes 11 may have a continuously connected shape. A description thereof will be provided below with reference to FIG. 6.

The insulating member 20, provided to insulate the lead wire 5a of the coil 5 from the base member 10, may be made of an insulating material including a resin material such as an epoxy resin, or the like. To this end, the insulating member 20 may be inserted into the coil hole 11 to be fixed thereto.

Since the insulating member 20 may be inserted into the lower portion of the coil hole 11 formed in the base member 10 to be fixed thereto, a processing of overturning the base in order to couple the insulating member thereto is not required, thereby simplifying an assembling process.

Meanwhile, the insulating member 20 may be configured of a small diameter part 11 having a relatively small outer diameter to correspond to the coil hole 11 and a large diameter part 22 having a relatively large outer diameter.

Accordingly, upward separation of the insulating member 20 is prevented by the large diameter part 22 and the stepped coil hole 11 and downward separation thereof is prevented by the printed circuit board 10, whereby an adhesive does not need to couple the insulating member 20 to the base member 10.

In addition, an effect of improving vibration resistance and impact resistance performances of the motor may be expected from the separation prevention effect of the insulating member 20.

Meanwhile, since the insulating member 20 has a shape corresponding to the coil hole 11, it does not occupy an additional space for coupling with the coil hole 11, whereby the motor may be thinned.

The insulating member 20 may include a constantinner diameter, thereby securing a path of the lead wire 5a. However, the inner diameter of the insulating member 20 is not limited to a constantly formed shape, but may also be formed to correspond to a shape of an outer surface of the insulating member 20 and may also be formed to have a tapered shape in which the path of the lead wire 5a is shortened.

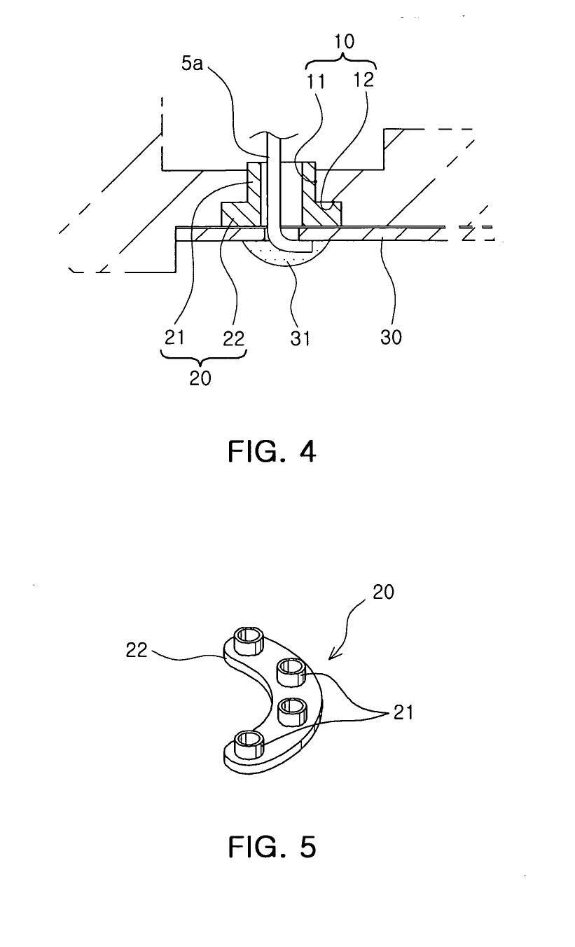

Meanwhile, the insulating member 20 may have one end formed to be higher than an upper surface of the base member 10. A description thereof will be provided below with reference to FIG. 4.

In addition, the insulating member 20 may have a shape in which large diameter parts 22 thereof are connected to each other, simultaneously being formed in corresponding to the plurality of coil hole 11. A description thereof will be provided below with reference to FIG. 5.

The printed circuit board 30 may be disposed on a lower surface of the base member 10, may be coupled to one surface of the insulating member 20, and may be electrically connected to one end of the lead wire 5a.

The printed circuit board 30 may be electrically connected to the lead wire 5a by the soldering, and the closing part 31 closing the coil hole 11 may be formed by the soldering.

Meanwhile, the printed circuit board 30 is electrically connected to the outside to serve to supply electrical energy to the motor.

A circuit pattern formed on the printed circuit board 30 is formed by attaching a copper foil onto the substrate, printing a resist in the form of a desired circuit pattern on a surface of the copper foil, dipping the substrate into an etchant capable of dissolving copper to thereby dissolve a portion of the copper foil to which the resist is not applied, and then allowing the copper foil having the desired circuit pattern to remain without being dissolved.

However, a method for forming the circuit pattern is not limited thereto, as long as it may supply electrical energy to the motor.

FIG. 4 is a partial cross-sectional view schematically showing a first example of a modified insulating member according to another exemplary embodiment of the present invention.

Referring to FIG. 4, the insulating member 20 may have one end formed to be higher than the upper surface of the base member 10.

Therefore, disconnection caused by electrical contact between the lead wire 5a and the upper surface of the base member 10 generated due to bending of the lead wire 5a may be prevented.

FIG. 5 is a perspective view schematically showing a second example of a modified insulating member according to another exemplary embodiment of the present invention.

Referring to FIG. 5, the insulating member 20 may be configured of small diameter parts 21 inserted into the plurality of coil holes 11 formed to be spaced from each other and having a relatively small outer diameter and large diameter parts 22 extended from one end of the small diameter parts 21 to be connected to each other and having a relatively large outer diameter.

Therefore, the insulating member 20 may be inserted into the plurality of coil holes 11 at one time, whereby an assembling process of the insulating member 20 and the coil holes 11 may be simplified.

FIG. 6 is a partial perspective view schematically showing a modified example of a base member according to another exemplary embodiment of the present invention.

Referring to FIG. 6, the base member 10 may be provided with the plurality coil holes 11 in corresponding to the insulating member 20 of which the large diameter parts 22 are connected to each other.

Therefore, a separate space is not required for coupling between the base member 10 and the insulating member 20, whereby the motor may be thinned.

As set forth above, the base assembly for a motor and the motor including the same according to the exemplary embodiments of the present invention may prevent the disconnection of the lead wire and the base and may simplify an assembling process.

Meanwhile, the separation of the insulating member due to rotation of the motor may be prevented, and the motor may be thinned.

In addition, an adhesive does not need to be used to bond the insulating member to the base.

While the present invention has been shown and described in connection with the exemplary embodiments, it will be apparent to those skilled in the art that modification and variation can be made without departing from the spirit and scope of the invention as defined by the appended claims.

What is claimed is:

1. A base assembly for a motor, comprising:
a base member including at least one coil hole having a lead wire of a coil passing therethrough and having an inner surface formed to be stepped, the coil generating a rotational driving force of a motor;
an insulating member inserted into the coil hole to be fixed thereto in order to prevent contact between the lead wire and the base member; and
a printed circuit board disposed on a lower surface of the base member, coupled to one surface of the insulating member, and electrically connected to one end of the lead wire.

2. The base assembly of claim 1, wherein the insulating member is configured of small diameter parts having a relatively small outer diameter and large diameter parts having a relatively large outer diameter.

3. The base assembly of claim 2, wherein the coil hole includes a plurality of coil holes, and the insulating member is configured of the small diameter parts inserted into the plurality of coil holes formed to be spaced apart from each other and having a relatively small outer diameter and the large diameter parts extended from one end of the small diameter parts to be connected to each other.

4. The base assembly of claim 1, wherein the coil hole has a shape corresponding to the insulating member.

5. The base assembly of claim 1, wherein one end of the insulating member is formed to be higher than an upper surface of the base member.

6. The base assembly of claim 1, wherein the insulating member has a constant inner diameter.

7. The base assembly of claim 1, wherein the inner surface of the coil hole has a stepped shape in which a diameter of a lower portion thereof is larger than that of an upper portion thereof.

8. The base assembly of claim 1, wherein the printed circuit board further includes a closing part closing the coil hole by soldering one end of the lead wire of the coil.

9. A motor, comprising:
a base assembly for a motor of claim 1;
a sleeve having the base assembly coupled to an outer peripheral surface thereof and having a shaft inserted thereinto to be supported;
a core fixedly disposed on an upper portion of the base assembly and having a coil wound therearound, the coil generating the rotational driving force; and
a rotor having a magnet mounted therein such that the rotor is coupled to the shaft to be rotated, the magnet being faced to the coil.
